(19) United States
(12) Patent Application Publication
(10) Pub. No.: US 2024/0147406 A1
(43) Pub. Date: May 2, 2024

(54) METHOD AND APPARATUS FOR NETWORK SLICE LOAD ANALYTICS

(71) Applicant: SAMSUNG ELECTRONICS CO., LTD., Suwon-si, Gyeonggi-do (KR)

(72) Inventors: Dongeun SUH, Suwon-si (KR); Jungshin PARK, Suwon-si (KR)

(21) Appl. No.: 18/500,920

(22) Filed: Nov. 2, 2023

(30) Foreign Application Priority Data
Nov. 2, 2022 (KR) 10-2022-0144335

(51) Int. Cl. H04W 60/04; H04W 48/18

(52) U.S. Cl. CPC H04W 60/04; H04W 48/18

(57) ABSTRACT

The disclosure relates to 5G or 6G communication systems to support higher data rates. According to an embodiment of the disclosure, in a method of analyzing a network slice load in a wireless communication system, a method for analyzing a network slice load based on the number of UEs that have established sessions and actually use data is provided.

### CROSS-REFERENCE TO RELATED APPLICATION

This application is based on and claims priority under 35 U. S. C. § 119 to Korean Patent Application No. 10-2022-0144335, filed on Nov. 2, 2022, in the Korean Intellectual Property Office, the disclosure of which is herein incorporated by reference in its entirety.

### BACKGROUND

### 1. Field

The present disclosure relates to a method and an apparatus for network slice load analytics.

### 2. Description of Related Art

5^{th} generation (5G) mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

The above information is presented as background information only to assist with an understanding of the disclosure. No determination has been made, and no assertion is made, as to whether any of the above might be applicable as prior art with regard to the disclosure.

### SUMMARY

The conventional network slice load analysis method collects the number of registered UEs for each slice along with time information and provides analysis information on the collected information. On the other hand, there may be a UE (i.e., inactive user equipment (UE)) that is registered in a slice but does not transmit user data to the data plane, and in this case, the number of registered UEs per slice may not be appropriate as load information for the slice.

To solve this problem, the disclosure provides analysis information based on the number of UEs that use actual data (i.e., UEs that have sessions) as new network slice load analysis information.

The disclosure provides a method of providing analysis information (statistical information, etc.) on the number of UEs (hereinafter referred to as activated UEs or active UEs) that have one or more PDU sessions or PDN connections among UEs registered in a network slice.

An embodiment of the disclosure to solve the problem discloses a method performed by a consumer network function (NF) in a wireless communication system, the method comprising: receiving, from an application function (AF), a first message requesting an event subscription for a network slice; transmitting, to a network slice access control function (NSACF), a second message requesting the event subscription for the network slice; and receiving, from the NSACF, event reporting information including information on number of user equipments (UEs) with at least one protocol data unit (PDU) session or packet data network (PDN) connection.

In an embodiment, the first message and the second message further include an event identifier indicating UEs with at least one PDU session or PDN connection.

In an embodiment, the first message and the second message further includes at least one of an event identifier indicating a number of inactive UEs, an event identifier indicating ratio of active UEs to registered UEs or an event identifier indicating ratio of inactive UEs to registered UEs, wherein the inactive UE is UE with no PDU session or PDN connection, and the event report information further includes at least one of information on the number of UEs with no PDU session, information on the ratio of active UEs to registered UEs or information on the ratio of inactive UEs to registered UEs.

In an embodiment, the method performed by the consumer NF further comprises step of transmitting, to the AF, the event reporting information.

Another embodiment of the disclosure to solve the problem discloses a method performed by a network slice access control function (NSACF) in a wireless communication system, the method comprising: receiving, from a consumer network function (NF), a second message requesting an event subscription for a network slice; and transmitting, to the consumer NF, event reporting information including information on number of equipments (UEs) with at least one protocol data unit (PDU) session or packet data network (PDN) connection.

The disclosure provides a method of providing analysis information (statistical information, etc.) on the number of UEs (hereinafter referred to as activated UEs or active UEs) that have one or more PDU sessions among UEs registered in a network slice. The network slice analysis information provided in this method may be used to determine the congestion status for each slice in AMF, reconfigure the quota value for each slice in NSSF, and determine the utilization rate (when provided along with the number of registered UEs by slice) for each slice or the congestion level by a third party.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a 5G system architecture according to an embodiment of the present disclosure;

FIG. 2 illustrates a flowchart of NF to subscribe to an NSACF for the number of active UEs for arbitrary network slice(s) and receive a notification about the subscription according to an embodiment of the present disclosure;

FIG. 3 illustrates a flowchart of a method of for providing analysis information on the number of active UE through the NWDAF according to an embodiment of the present disclosure;

FIG. 4 illustrates a flowchart of consumer NF to subscribe to an AMF for the number of active UEs for arbitrary network slice(s) and receive a notification about the subscription according to an embodiment of the present disclosure;

FIG. 5 illustrates a flowchart of consumer NF to subscribe to an SMF for PDU session generation and release events for arbitrary network slice(s) and receive a notification about the subscription according to an embodiment of the present disclosure;

FIG. 6 illustrates a flowchart of AF to request the number of active UEs for each slice according to an embodiment of the present disclosure; and

FIG. 7 illustrates a structure of a node according to an embodiment of the present disclosure.

### DETAILED DESCRIPTION

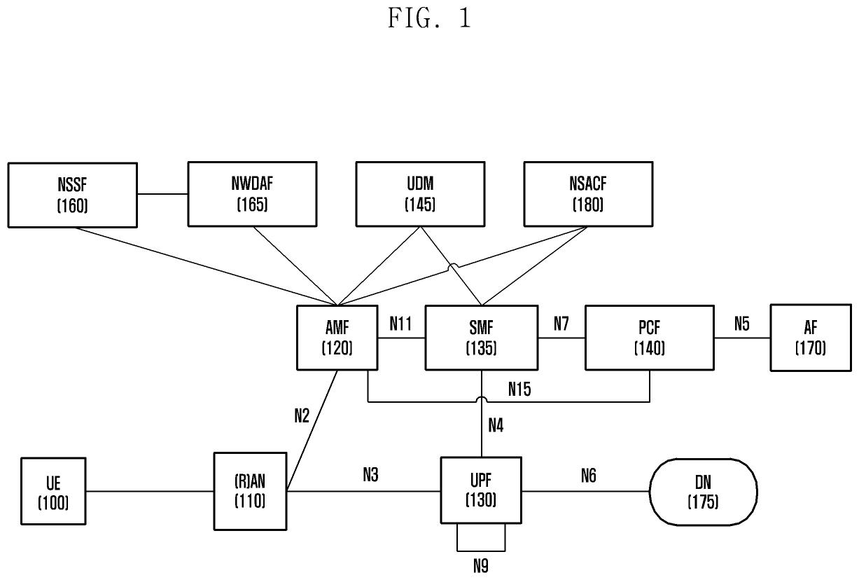

FIGS. 1 through 7, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

In describing embodiments of the disclosure, descriptions related to technical contents well-known in the art and not associated directly with the disclosure will be omitted. Such an omission of unnecessary descriptions is intended to prevent obscuring of the main idea of the disclosure and more clearly transfer the main idea.

For the same reason, in the accompanying drawings, some elements may be exaggerated, omitted, or schematically illustrated. Furthermore, the size of each element does not completely reflect the actual size. In the drawings, identical or corresponding elements are provided with identical reference numerals.

The advantages and features of the disclosure and ways to achieve them will be apparent by making reference to embodiments as described below in detail in conjunction with the accompanying drawings. However, the disclosure is not limited to the embodiments set forth below, but may be implemented in various different forms. The following embodiments are provided only to completely disclose the disclosure and inform those skilled in the art of the scope of the disclosure, and the disclosure is defined only by the scope of the appended claims. Throughout the specification, the same or like reference numerals designate the same or like elements.

Herein, it will be understood that each block of the flowchart illustrations, and combinations of blocks in the flowchart illustrations, can be implemented by computer program instructions. These computer program instructions can be provided to a processor of a general-purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Furthermore, each block of the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

As used in embodiments of the disclosure, the “unit” refers to a software element or a hardware element, such as a field programmable gate array (FPGA) or an application specific integrated circuit (ASIC), which performs a predetermined function. However, the “unit” does not always have a meaning limited to software or hardware. The “unit” may be constructed either to be stored in an addressable storage medium or to execute one or more processors. Therefore, the “unit” includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may be either combined into a smaller number of elements, or a “unit,” or divided into a larger number of elements, or a “unit.” Moreover, the elements and “units” or may be implemented to reproduce one or more CPUs within a device or a security multimedia card.

Hereinafter, the operation principle of the disclosure will be described in detail with reference to the accompanying drawings. In the following description of the disclosure, a detailed description of known functions or configurations incorporated herein will be omitted when it is determined that the description may make the subject matter of the disclosure unnecessarily unclear. The terms which will be described below are terms defined in consideration of the functions in the disclosure, and may be different according to users, intentions of the users, or customs. Therefore, the definitions of the terms should be made based on the contents throughout the specification.

In the following description, terms for identifying access nodes, terms referring to network entities, terms referring to messages, terms referring to interfaces between network entities, terms referring to various identification information, and the like are illustratively used for the sake of descriptive convenience. Therefore, the disclosure is not limited by the terms as used below, and other terms referring to subjects having equivalent technical meanings may be used.

In the following description of the disclosure, terms and names specified in the 5GS and NR standards, which are the latest standards defined by the 3rd generation partnership project (3GPP) group among the existing communication standards, will be used for the sake of descriptive convenience. However, the disclosure is not limited by these terms and names, and may be applied in the same way to systems that conform other standards. For example, the disclosure may be applied to 3GPP 5GS/NR (5th generation mobile communication standards).

The 5G mobile communication network consists of 5G UE (user equipment, terminal), 5G RAN (radio access network, base station), gNB (5 GnodeB), eNB (evolved nodeB, etc.), and 5G core network. The 5G core network consists of NFs such as access and mobility management function (AMF) that provides UE mobility management functions, session management function (SMF) that provides session management functions, user plane function (UPF), which performs the role of data transmission, policy control function (PCF) that provides policy control functions, unified data management (UDM) that provides data management functions such as subscriber data and policy control data, and unified data repository (UDR) that stores data of various network functions (NF) such as UDM.

In the 3GPP system, the conceptual link connecting NFs in the 5G system is defined as a reference point. The following illustrates reference points included in the 5G system architecture illustrated in FIG. 1:
N1: Reference point between UE and AMF;
N2: Reference point between (R)AN and AMF;
N3: Reference point between (R)AN and UPF;
N4: Reference point between SMF and UPF; N5: Reference point between PCF and AF;
N6: Reference point between UPF and DN;
N7: Reference point between SMF and PCF;
N8: Reference point between UDM and AMF;
N9: Reference point between two core UPFs;
N10: Reference point between UDM and SMF;
N11: Reference point between AMF and SMF;
N12: Reference point between AMF and AUSF;
N13: Reference point between UDM and authentication server function (AUSF);
N14: Reference point between two AMFs; and/or
N15: Reference point between PCF and AMF for non-roaming scenarios, and reference point between PCF and AMF within a visited network for roaming scenarios.

In the 5G system, network slicing refers to a technology and structure that enables multiple virtualized and independent logical networks in a physical network. To satisfy the specialized requirements of services/applications, network operators provide services by configuring a virtual end-to-end network called a network slice. In this case, the network slice is identified by an identifier called single-network slice selection assistance information (S-NSSAI). The network transmits a set of slices (e.g., allowed NSSAI(s)) allowed to the UE in a UE registration procedure (e.g., UE registration procedure), and the UE transmits and receives application data through a protocol data unit (PDU) session generated through one S-NSSAI (i.e., a network slice) among the set of slices (e.g., allowed NSSAI(s)).

In the present disclosure, among UEs registered in arbitrary network slice, a UE that has one or more PDU session or PDN connections for the slice is called a UE activated for the slice or an active UE. In addition, among the UEs registered in a network slice, a UE that does not have a PDU session or PDN connection for the slice is called a deactivated UE or inactive UE.

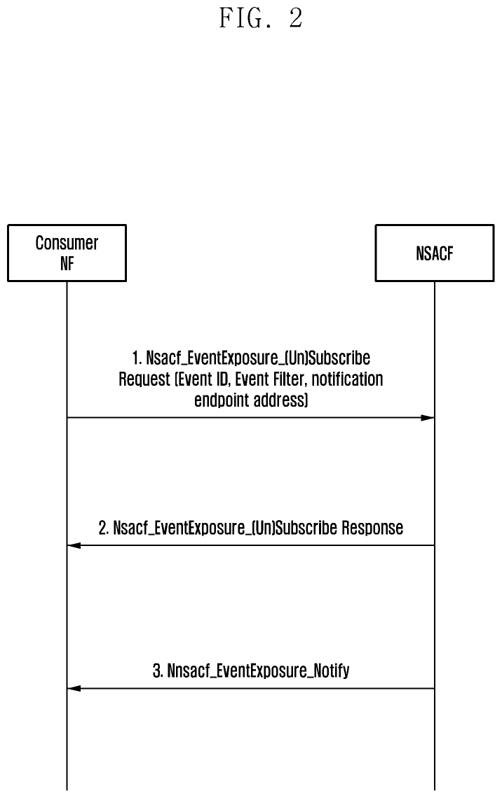

FIG. 2 illustrates a flowchart of NF to subscribe to an NSACF for the number of active UEs for arbitrary network slice(s) and receive a notification about the subscription according to an embodiment of the present disclosure.

In one embodiment of Step 1, the consumer NF may transmit a subscribe request (or unsubscribe request) to the NSACF to receive information corresponding to the event ID. In this case, the corresponding message may include the following information:

In one example, an event ID may indicate one of the event identifier values indicating an event identifier value indicating information on the number of active UEs (i.e., UEs with at least one PDU session or PDN connection), an event identifier value indicating the number of inactive UEs (i.e., UEs with no PDU session), active ratio (i.e., the number of active UEs/the number of registered UEs), and inactive ratio (i.e., the number of inactive UEs/the number of registered UEs).

In one example of event filter, event filter information may include S-NSSAI(s) and regional information. For example, if the event ID is the number of active UEs and the event filter includes S-NSSAI, this requests information on the number of active UEs for the S-NSSAI.

In one example, a notification endpoint address indicates the address where notifications including information corresponding to the event ID is received. The address of the consumer NF or the address of another NF may be included.

In one example of immediate report flag, if the consumer NF wants immediate reporting, this information may be included.

In one example of one-time reporting, if the consumer NF wants one time reporting, this information may be included.

In another embodiment of Step 2, if the message received in step 1 is a message for a subscribe request, and if the NSACF supports the event ID of the message (that is, if the message received is an event expose subscribe request), and if the NSACF supports the event ID of the message, the NSACF internally stores subscription information for transmitting a response to the request, and includes information indicating success in the message transmitted to the consumer NF. If the message received in step 1 includes an immediate report flag, the response message transmitted in step 2 may include the information (i.e., the number of active UEs, the number of inactive UEs, active ratio, or inactive ratio depending on the event ID and event filter) transmitted in step 3, or step 3 may be executed immediately after step 2.

If the message received in step 1 is a message for a request to unsubscribe (i.e., unsubscribe request), the NSACF may delete the subscription information corresponding to the event ID included in the message for the consumer NF and then include information notifying that the subscription information is deleted in the response message transmitted to the consumer NF.

In one embodiment of Step 3, when receiving the notification endpoint address in step 1, the NSACF may include the following information according to the event ID received in step 1 in the message transmitted to the corresponding address (to the consumer NF if not received).

When the event ID indicates a value corresponding to the number of active UEs, if information on the number of UEs activated for each S-NSSAI is available for the S-NSSAI(s) included in the message received in step 1, the NSACF includes a timestamp related to the corresponding information. Alternatively, When the event ID indicates a value corresponding to the number of active UEs, if an event occurs that increases or decreases the number of UEs activated for the S-NSSAI(s) included in the message received in step 1, the NSACF may include one or more of information indicating that the number of active UEs for each S-NSSAI is increased or decreased for the corresponding S-NSSAI(s), the number of currently activated UEs, and the related timestamp.

When the event ID indicates a value corresponding to the number of inactive UEs, if information on the number of UEs deactivated for each S-NSSAI is available for the S-NSSAI included in the message received in step 1, the NSACF includes a timestamp related to the corresponding information. Alternatively, When the event ID indicates a value corresponding to the number of inactive UEs, if an event occurs that increases or decreases the number of UEs deactivated for the S-NSSAI(s) included in the message received in step 1, the NSACF may include one or more of information indicating that the number of inactive UEs for each S-NSSAI is increased or decreased for the corresponding S-NSSAI(s), the number of currently deactivated UEs, and the related timestamp.

When the event ID indicates a value corresponding to the active ratio, the NSACF includes a timestamp related to the number of active UEs for S-NSSAI included in the message received in step 1 divided by the number of registered UEs for S-NSSAI included in the message received in step 1. Alternatively, When the event ID indicates a value corresponding to the active ratio, if an event occurs that increases or decreases the active ratio for the S-NSSAI(s) included in the message received in step 1, the NSACF may include one or more of information indicating that the active ratio for each S-NSSAI is increased or decreased for the corresponding S-NSSAI(s), the current active ratio, and the related timestamp.

When the event ID indicates a value corresponding to the inactive ratio, the NSACF includes a timestamp related to the number of inactive UEs for S-NSSAI included in the message received in step 1 divided by the number of registered UEs for S-NSSAI included in the message received in step 1. Alternatively, When the event ID indicates a value corresponding to the inactive ratio, if an event occurs that increases or decreases the inactive ratio for the S-NSSAI(s) included in the message received in step 1, the NSACF may include one or more of information indicating that the inactive ratio for each S-NSSAI is increased or decreased for the corresponding S-NSSAI(s), the current inactive ratio, and the related timestamp.

When the message received in step 1 includes slice information and regional information, the NSACF may include information (e.g., the number of active UEs, the number of inactive UEs, active ratio, and inactive ratio) on the corresponding slice and region in the message transmitted to the consumer NF.

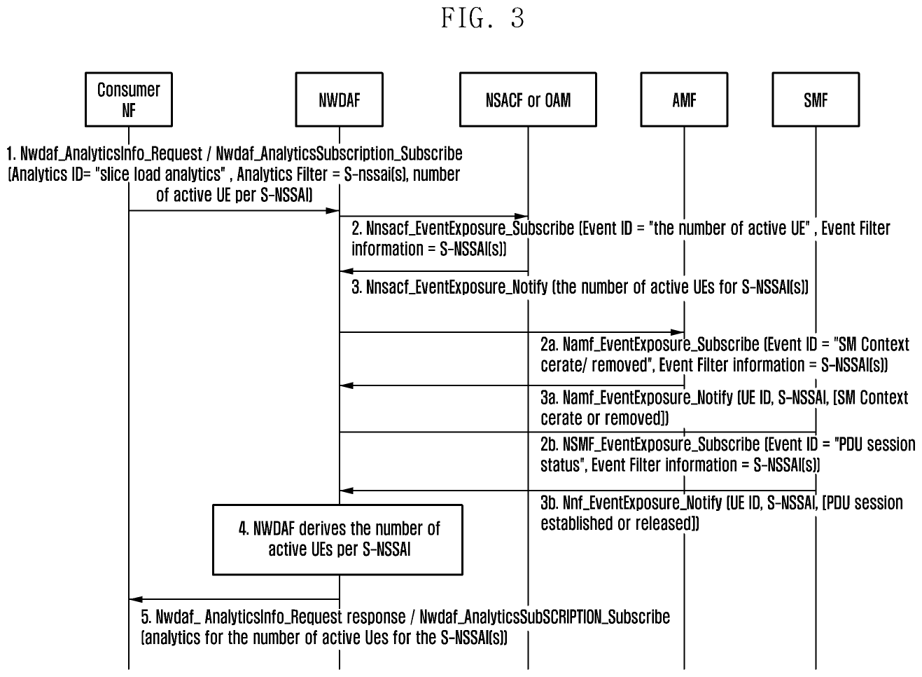

FIG. 3 illustrates a flowchart of a method for providing analysis information on the number of active UE through the NWDAF according to an embodiment of the present disclosure.

In one embodiment of Step 1, the consumer NF may transmit a message to request analysis information on slice load information based on the number of active UEs to the NWDAF. The message may include the following information as shown in following examples.

In one example of analytics ID, this is an analysis information identifier and is configured to a value representing slice load analytics.

In one example of analytics filter, this is information representing the analysis information filter and may include desired information for each field. Information on the slice identifier field may include the S-NSSAI(s) to be requested. Fields indicating the type of slice load information may include the number of active UEs, the number of registered UEs for each S-NSSAI, the number of PDU sessions for each S-NSSAI, the number of inactive UEs for each S-NSSAI, active ratio, inactive ratio, etc.

Alternatively, when the slice load analytics is not used as the analysis information identifier in the request message, the analysis information identifier may be configured to a value representing one or more of the number of active UEs, the number of inactive UEs, the active ratio, and the inactive ratio. In this case, the analytics filter includes slice identifier information (i.e., S-NSSAI(s)) and does not include information on the slice load information type.

In another embodiment of Step 2, the NWDAF may determine what analysis information is being requested based on the analysis information identifier, the field(s) indicating the type of slice load information, and the field(s) indicating the slice identifier included in the message received in step 1, and decide to collect the information necessary to provide the relevant analysis information. If the message received in step 1 requests analysis information on one or more of the number of active UEs, number of inactive UEs, active ratio, and inactive ratio for a specific S-NSSAI(s), the NWDAF may transmit a request message for collecting corresponding information to NSACF(s) or OAM (step 2 and step 3) in charge of the corresponding S-NSSAI(s), AMF(s) (step 2a and step 3a) in charge of the corresponding S-NSSAI(s) or SMF(s) (step 2b and step 3b) in charge of the corresponding S-NSSAI(s). The NWDAF may transmit an information collection request message to AMF(s) or SMF(s) if the NSACF or OAM fails to provide the information required to generate the requested analysis information among the S-NSSAI(s) included in the message received in step 1 (e.g., in the case of the S-NSSAIs that are not subject to NSAC or if the NSACF does not exist).

When the NWDAF transmits a request message for information collection to the NSACF, the message has the same form as the message transmitted in step 1 of FIG. 2, and the event ID in the message is configured according to the analytics ID received in step 1 and/or the field(s) indicating the type of slice load information in the analytics filter (for example, if the number of active UEs are included in the slice load information type field with an analytics ID representing slice load information, the event ID is configured to a value corresponding to the number of active UEs). The S-NSSAI(s) in the request message transmitted from the NWDAF to the NSACF may be configured to the S-NSSAI(s) values in the message received in step 1.

In yet another embodiment of Step 3, the NSACF or OAM transmits a message in the same format as the message in step 3 of FIG. 2 to the NWDAF. In this case, the information included in the message is determined according to the event ID and S-NSSAI(s) included in the message received in step 2. For example, if the message received in step 2 includes an event ID corresponding to the number of active UEs, the NSACF or OAM may include timestamp information related to the activated UE (i.e., a UE with at least one PDU session or PDN connection) for each S-NSSAI for the S-NSSAI(s) received in step 2 in the message transmitted to the NWDAF. Alternatively, if the message received in step 2 includes an event ID corresponding to the number of active UEs, the NSACF or OAM may include timestamp information related to information indicating an increase or decrease in the number of active UEs (i.e., UE with at least one PDU session or PDN connection) for each S-NSSAI for the S-NSSAI(s) received in step 2 in the message transmitted to the NWDAF, and the number of active UEs. The NSACF or OAM may transmit a message to the NWDAF periodically or when an increase or decrease event of the active UE occurs.

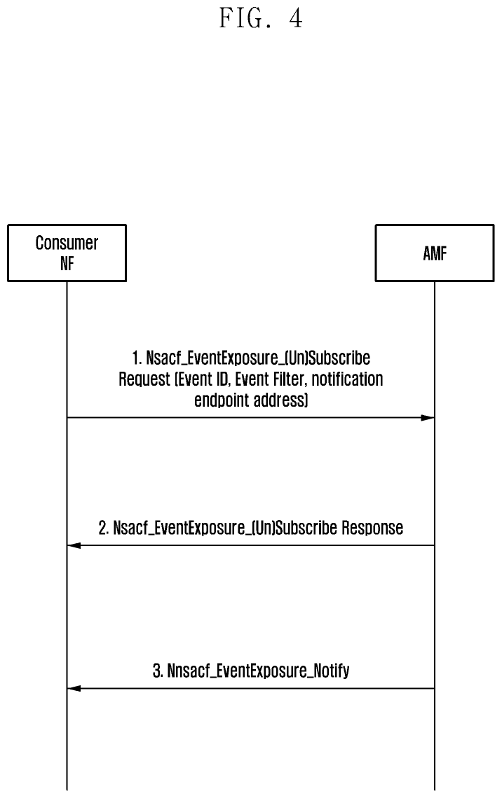

In yet another embodiment of Step 2a, when the NWDAF transmits a request message for information collection to the AMF, the message has the same form as the message transmitted in step 1 of FIG. 4. The S-NSSAI(s) in the request message transmitted from the NWDAF to the AMF may be configured to the S-NSSAI(s) values in the message received in step 1.

In yet another embodiment of Step 3a, when receiving the message in step 2a, the AMF transmits a message of the same type as the message in step 3 of FIG. 4 to the NWDAF. In this case, the information included in the message is determined according to the event ID and S-NSSAI(s) included in the message received in step 2a. The AMF may transmit the message in step 3 of FIG. 4 to the NWDAF periodically or when an SM context generation/release event for each slice occurs, or when the first SM context generation (or when selecting an SMF)/last SM context release event for each slice occurs.

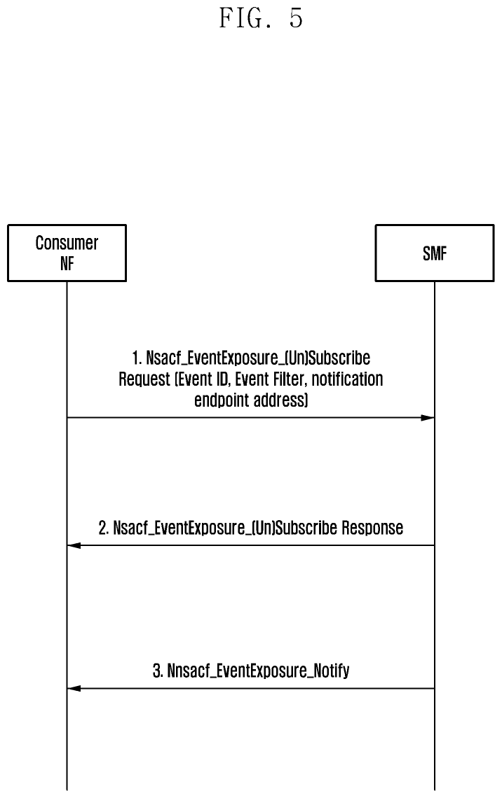

In yet another embodiment of Step 2b, when the NWDAF transmits a request message for information collection to the SMF, the message has the same form as the message transmitted in step 1 of FIG. 5. The S-NSSAI(s) in the request message transmitted from the NWDAF to the SMF may be configured to the S-NSSAI(s) values in the message received in step 1.

In yet another embodiment of Step 3b, when receiving the message in step 2b, the SMF transmits a message of the same type as the message in step 3 of FIG. 5 to the NWDAF. In this case, the information included in the message is determined according to the event ID and S-NSSAI(s) included in the message received in step 2b. The SMF may transmit the message in step 3 of FIG. 5 to the NWDAF periodically or when a PDU session (or SM context) generation/release event for each slice occurs, or when the first PDU session (or SM context) generation/last PDU session (or SM context) release event for each slice occurs.

In yet another embodiment of Step 4, the NWDAF calculates the corresponding analysis information (that is, it may be one or more of the analysis information among the number of active UEs, the number of inactive UEs, active ratio, and inactive ratio) based on the information received in step 3 (or step 3a or step 3b).

In yet another embodiment of Step 5, the NWDAF may include analysis information corresponding to the analysis information requested by the message received in step 1 in a response message to the analysis information request message received in step 1. For example, if the message in step 1 includes information indicating the S-NSSAI in the message and the number of active UE, The NWDAF may include statistical information (e.g., average value, standard deviation value, variance value, information on the number of active UEs over time, etc.) on the number of active UEs of the corresponding S-NSSAI in the message transmitted to the consumer NF.

FIG. 4 illustrates a flowchart of a consumer NF to subscribe to an AMF for the number of active UEs for arbitrary network slice(s) and receive a notification about the subscription according to an embodiment of the present disclosures.

In one embodiment of Step 1, the consumer NF may transmit a subscribe request (or unsubscribe request) to the AMF to receive information corresponding to the event ID. In this case, the corresponding message may include the following information as shown in following examples.

In one example of event ID, the SM context may include an event identifier value indicating creation or release, or an event value indicating the number of active UEs (i.e., the number of UEs with at least one PDU session on a S-NSSAI).

In one example of event filter, event filter information may include S-NSSAI(s) and regional information.

For example, if the event ID is an event identifier value indicating generation or release in the SM context and event filter includes S-NSSAI, this is a request to be notified when the SM context is generated or released for the corresponding S-NSSAI.

In one example, notification endpoint address indicates the address where notifications including information corresponding to the event ID is received. The address of the consumer NF or the address of another NF may be included.

In one example of immediate report flag, if the consumer NF wants immediate reporting, this information may be included.

In one example of one-time reporting, if the consumer NF wants one time reporting, this information may be included.

In one embodiment of Step 2, if the message received in step 1 is a message for a subscribe request (that is, an event expose subscribe request), and if the AMF supports the event ID of the message, the AMF internally stores subscription information for transmitting a response to the request, and includes information indicating success in the message transmitted to the consumer NF. If the message received in step 1 includes an immediate report flag, the response message transmitted in step 2 may include the information (i.e., information indicating SM context generation or release according to event ID, the number of active UEs) transmitted in step 3, or step 3 may be executed immediately after step 2.

If the message received in step 1 is a message for a request to unsubscribe (i.e., unsubscribe request), the AMF may delete the subscription information corresponding to the event ID included in the message for the consumer NF and then include information notifying that the subscription information is deleted in the response message transmitted to the consumer NF.

In one embodiment of Step 3, when receiving the notification endpoint address in step 1, the AMF may include the following information according to the event ID received in step 1 in the message transmitted to the corresponding address (to the consumer NF if not received).

When the event ID indicates a value corresponding to the SM context generation or release, the AMF may internally store the corresponding UE ID, S-NSSAI, information indicating SM context generation or release, and related timestamp, and include them in the message transmitted to the consumer NF when generating or releasing the SM context for each S-NSSAI for the S-NSSAI(s) included in the message received in step 1. The AMF may transmit the above information to the consumer NF when the SM context generation or release event occurs, or periodically.

Alternatively, when the event ID indicates a value corresponding to the SM context generation or release, the AMF may internally store the corresponding UE ID, S-NSSAI, information indicating SM context generation or release, and related timestamp, and include them in the message transmitted to the consumer NF when generating the first SM context for the corresponding S-NSSAI or releasing the last SM context for each S-NSSAI for the S-NSSAI(s) included in the message received in step 1. The AMF may transmit the above information to the consumer NF when generating the first SM context or releasing the last SM context occurs.

When the event ID indicates a value corresponding to the number of active UEs, if information on the number of UEs activated for each S-NSSAI is available for the S-NSSAI(s) included in the message received in step 1, the AMF includes a timestamp related to the corresponding information. Alternatively, when the event ID indicates a value corresponding to the number of active UEs, if an event occurs that increases or decreases the number of UEs activated for the S-NSSAI(s) included in the message received in step 1, the AMF may include one or more of information indicating that the number of active UEs for each S-NSSAI is increased or decreased for the corresponding S-NSSAI(s), the number of currently activated UEs, and the related timestamp.

FIG. 5 illustrates a flowchart of a consumer NF to subscribe to an SMF for PDU session generation and release events for arbitrary network slice(s) and receives a notification about the subscription according to an embodiment of the present disclosure.

In one embodiment of Step 1, the consumer NF may transmit a subscribe request (or unsubscribe request) to the AMF to receive information corresponding to the event ID. In this case, the corresponding message may include the following information as shown in following examples.

In one example of event ID, an event identifier value indicating the generation or release of a PDU session (or SM context) or an event value indicating the number of active UEs (i.e., the number of UEs with at least one PDU session on a S-NSSAI) may be included.

In one example of event filter, event filter information may include S-NSSAI(s) and regional information.

For example, if the event ID is an event identifier value indicating the generation or release of a PDU session (or SM context) and event filter includes S-NSSAI, this is a request to be notified when the SM context is generated or released for the corresponding S-NSSAI.

In one example, notification endpoint address indicates the address where notifications including information corresponding to the event ID is received. The address of the consumer NF or the address of another NF may be included.

In one example of immediate report flag, if the consumer NF wants immediate reporting, this information may be included.

In one example of one-time reporting, if the consumer NF wants one time reporting, this information may be included.

In another embodiment of Step 2, if the message received in step 1 is a message for a subscribe request (that is, an event expose subscribe request), and if the SMF supports the event ID of the message, the SMF internally stores subscription information for transmitting a response to the request, and includes information indicating success in the message transmitted to the consumer NF. If the message received in step 1 includes an immediate report flag, the response message transmitted in step 2 may include the information (i.e., information indicating the generation or release of a PDU session (or SM context) according to the event ID, the number of active UEs) transmitted in step 3, or step 3 may be executed immediately after step 2.

If the message received in step 1 is a message for a request to unsubscribe (i.e., unsubscribe request), the SMF may delete the subscription information corresponding to the event ID included in the message for the consumer NF and then include information notifying that the subscription information is deleted in the response message transmitted to the consumer NF.

In yet another embodiment of Step 3, when receiving the notification endpoint address in step 1, the SMF may include the following information according to the event ID received in step 1 in the message transmitted to the corresponding address (to the consumer NF if not received).

When the event ID indicates a value corresponding to the generation or release of a PDU session (or SM context), the SMF may internally store the corresponding UE ID, S-NSSAI, information indicating the generation or release of a PDU session (or SM context), and related timestamp, and include them in the message transmitted to the consumer NF when generating or releasing the SM context for each S-NSSAI for the S-NSSAI(s) included in the message received in step 1. The SMF may transmit the above information to the consumer NF when a PDU session (or SM context) generation or release event occurs, or periodically.

Alternatively, when the event ID indicates a value corresponding to the generation or release of a PDU session (or SM context), the SMF may internally store the corresponding UE ID, S-NSSAI, information indicating the generation or release of a PDU session (or SM context), and related timestamp, and include them in the message transmitted to the consumer NF when generating the first PDU session (or SM context) for the corresponding S-NSSAI or releasing the last PDU session (or SM context) for each S-NSSAI for the S-NSSAI(s) included in the message received in step 1. The SMF may transmit the above information to the consumer NF when generating the first PDU session (or SM context) or releasing the last PDU session (or SM context) event occurs, or periodically.

When the event ID indicates a value corresponding to the number of active UEs, if information on the number of UEs activated for each S-NSSAI is available for the S-NSSAI(s) included in the message received in step 1, the SMF includes a timestamp related to the corresponding information. Alternatively, When the event ID indicates a value corresponding to the number of active UEs, if an event occurs that increases or decreases the number of UEs activated for the S-NSSAI(s) included in the message received in step 1, the SMF may include one or more of information indicating that the number of active UEs for each S-NSSAI is increased or decreased for the corresponding S-NSSAI(s), the number of currently activated UEs, and the related timestamp.

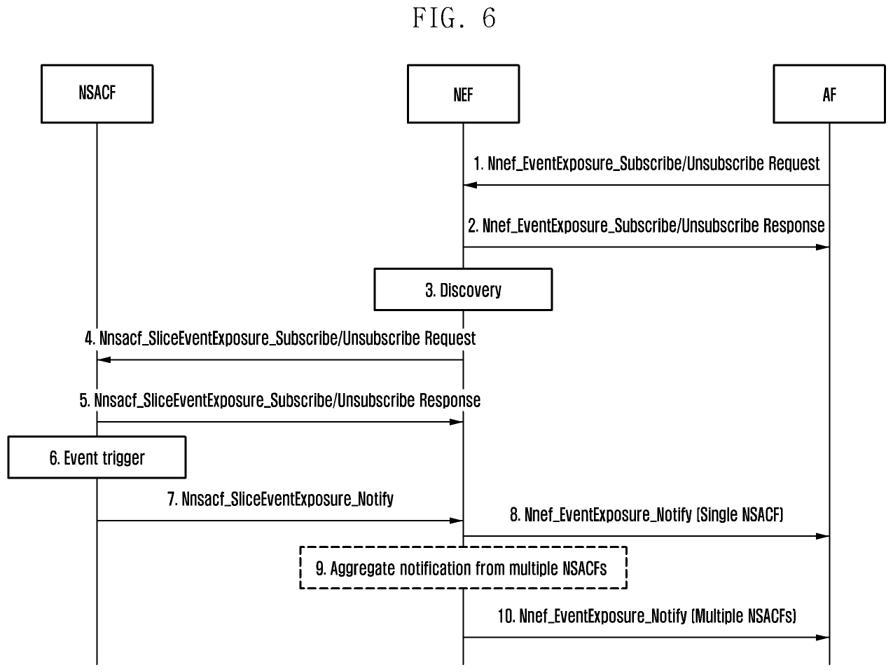

FIG. 6 illustrates a flowchart of AF to request the number of active UEs for each slice according to an embodiment of the present disclosure.

In one embodiment of Step 1, the AF transmits a message including the following information to the NEF to subscribe or unsubscribe for one or more of the number of active UEs, number of inactive UEs, active ratio, and inactive ratio for each network slice:

In one embodiment, event ID indicates an event identifier and may be configured to a value indicating one or more of the number of active UEs, the number of inactive UEs, active ratio, and inactive ratio depending on the information desired by the AF.

In one embodiment of event filter, slice identifier information (S-NSSAI(s)) may be included.

In one embodiment of event reporting information, one-time reporting and/or immediate reporting flag may be included. The AF may include one-time reporting and immediate reporting flags when only one notification is desired and when an immediate response is desired, respectively.

In one embodiment of S-NSSAI, slice identifier information (i.e., S-NSSAI) for which the AF requests subscription information may be included.

In another embodiment of Step 2, the NEF transmits a response message to the AF. If event reporting information is included in step 1, the response message may include possible event reporting. If the AF that transmitted the message in step 1 is an untrusted AF, the NEF may include the AF-Service-Identifier for the S-NSSAI included in step 1 in the response message. If immediate reporting or one-time reporting is requested, step 1 is performed after step 5 and the response message may include immediate reporting or one-time reporting. In the case of one-time reporting, subscription information is not generated in the NEF or the NSACF.

In yet another embodiment of Step 3, the NEF may transmit a query message including the corresponding S-NSSAI(s) and the NF type configured to the NSACF to the NRF to find NSACF(s) for the S-NSSAI(s) included in Step 1. If necessary, the NEF may include the corresponding S-NSSAI value in the query message instead of the AF-service-Identifier.

In yet another embodiment of Step 4, if the NEF has not yet subscribed to the event for the S-NSSAI(s) included in Step 1, the NEF may transmit an event subscription or release message including the following information to all NSACFs that support the corresponding S-NSSAI(s).

In one example, an event ID indicates an event identifier and may be configured to the event ID of the message received from the AF in step 1.

In one example, event filter is configured to the S-NSSAI(s) of the message received from the AF in step 1.

In one example of event reporting information, one-time reporting and/or immediate reporting flag and/or periodic reporting may be included.

In one example of S-NSSAI, the S-NSSAI received in step 1 may be included.

If there are multiple NSACFs for S-NSSAI(s) included in the message received in step 1, the NEF may include a periodic reporting in event reporting information. If there are multiple NSACFs for S-NSSAI(s) included in the message received in step 1, the NEF may include the same information as the event reporting information of the message received from the AF in step 1 in the event reporting information.

In yet another embodiment of Step 5, the NSACF(s) transmits a response message to the NEF for the message received in Step 4. The message may include an event reporting method that the NSACF may support among the event reporting information included in the message received in step 4.

In yet another embodiment of Step 6, if the reporting conditions for the subscribed event are satisfied, the NSACF transmits a notification to the NEF.

In yet another embodiment of Step 7, the NSACF transmits a message including event ID and event reporting information to the NEF. If the subscription information includes information on event-based notifications (e.g., threshold value-based notifications), the event reporting information may include information indicating whether the event is satisfied. If the subscription information includes periodic reporting or immediate reporting, the event reporting information may include information (i.e., the number of active UEs, the number of inactive UEs, the active ratio, the inactive ratio) corresponding to the event ID for each S-NSSAI for the S-NSSAI(s) included in the subscription information.

In yet another embodiment of Step 8, if only a single NSACF is returned from the previous NSACF discovery procedure via the NRF, the NEF may include the event ID and event reporting information received in step 7 in the message transmitted to the AF.

In yet another embodiment of Step 9, if multiple NSACFs are returned from the previous NSACF discovery procedure via the NRF (i.e., if there are multiple NSACs responsible for the S-NSSAI(s) requested in Step 1), the NEF may collect event reporting information in messages received from multiple NSACFs and update/maintain the number of active UEs (or, the number of inactive UEs, the active ratio, the inactive ratio) for each S-NSSAI through the collected information.

In yet another embodiment of Step 10, if there are multiple NSACs in charge of the S-NSSAI(s) requested in step 1, and the reporting conditions for events subscribed by the AF are satisfied (for example, if the number of active UEs per S-NSSAI becomes above or below a specific threshold), the NEF may include event reporting information, including the event ID and information that the event is satisfied, in the message transmitted to the AF.

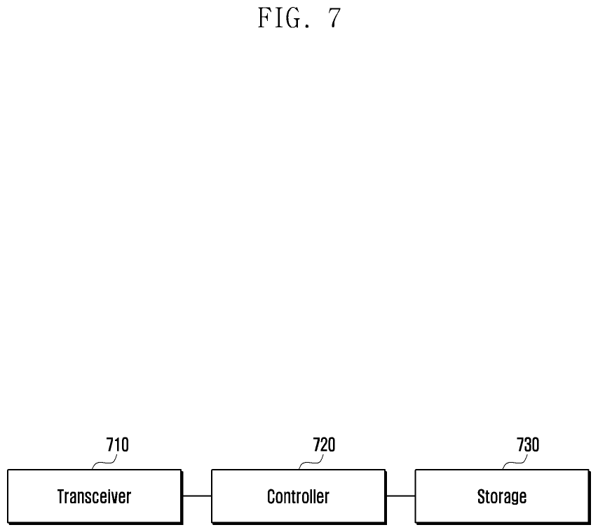

FIG. 7 illustrates a structure of a node according to an embodiment of the present disclosure.

The node illustrated in FIG. 7 may be composed of one of various types of network entities disclosed in the disclosure, for example, a consumer NF, an NSACF, an NWDAF, an OAM, an AMF, an SMF, an NEF, an AF, etc.

Referring to FIG. 7, the node may include a transceiver 710, a controller 720, and a storage 730. In the disclosure, the controller may be defined as a circuit, an application-specific integrated circuit, or at least one processor.

The transceiver unit 710 may transmit and receive signals with other network entities. For example, the transceiver 710 may receive system information from a UE, a base station, or another network object, and may receive a synchronization signal or a reference signal.

The controller 720 may control the overall operation of the UE according to the embodiment provided by the disclosure. For example, if the node is a consumer NF, the controller 720 may control the node to transmit a subscribe request to the NSACF and obtain related information when the number of active UEs changes accordingly.

The storage 730 may store at least one of information transmitted and received through the transceiver 710 and information generated through the controller 720. For example, if the node is the NWDAF, the storage 730 may store information such as an analytics ID and an analytics filter received from the consumer NF.

The methods according to various embodiments described in the claims or the specification of the disclosure may be implemented by hardware, software, or a combination of hardware and software.

When the methods are implemented by software, a computer-readable storage medium for storing one or more programs (software modules) may be provided. The one or more programs stored in the computer-readable storage medium may be configured for execution by one or more processors within the electronic device. The at least one program may include instructions that cause the electronic device to perform the methods according to various embodiments of the disclosure as defined by the appended claims and/or disclosed herein.

The programs (software modules or software) may be stored in non-volatile memories including a random access memory and a flash memory, a read only memory (ROM), an electrically erasable programmable read only memory (EEPROM), a magnetic disc storage device, a compact disc-ROM (CD-ROM), digital versatile discs (DVDs), or other type optical storage devices, or a magnetic cassette. Alternatively, any combination of some or all of them may form a memory in which the program is stored. Further, a plurality of such memories may be included in the electronic device.

In addition, the programs may be stored in an attachable storage device which may access the electronic device through communication networks such as the Internet, Intranet, local area network (LAN), wide LAN (WLAN), and storage area network (SAN) or a combination thereof. Such a storage device may access the electronic device via an external port. Further, a separate storage device on the communication network may access a portable electronic device.

In the above-described detailed embodiments of the disclosure, an element included in the disclosure is expressed in the singular or the plural according to presented detailed embodiments. However, the singular form or plural form is selected appropriately to the presented situation for the convenience of description, and the disclosure is not limited by elements expressed in the singular or the plural. Therefore, either an element expressed in the plural may also include a single element or an element expressed in the singular may also include multiple elements.

Although specific embodiments have been described in the detailed description of the disclosure, it will be apparent that various modifications and changes may be made thereto without departing from the scope of the disclosure. Therefore, the scope of the disclosure should not be defined as being limited to the embodiments, but should be defined by the appended claims and equivalents thereof.

Although the present disclosure has been described with various embodiments, various changes and modifications may be suggested to one skilled in the art. It is intended that the present disclosure encompass such changes and modifications as fall within the scope of the appended claims.

What is claimed is:

1. A method performed by a consumer network function (NF) in a wireless communication system, the method comprising:
receiving, from an application function (AF), a first message requesting an event subscription for a network slice;
transmitting, to a network slice access control function (NSACF), a second message requesting the event subscription for the network slice in response to receiving, from the AF, the first message; and
receiving, from the NSACF, event reporting information including information for a number of user equipments (UEs) along with at least one of a protocol data unit (PDU) session or a packet data network (PDN) connection.

2. The method of claim 1, wherein the first message and the second message further include an event identifier, respectively, indicating the number of UEs along with the at least one of the PDU session or the PDN connection.

3. The method of claim 1, wherein:
the first message and the second message further include at least one of an event identifier indicating a number of inactive UEs, respectively, the event identifier indicating a ratio of a number of active UEs to a number of registered UEs or the event identifier indicating the ratio of the number of inactive UEs to the number of registered UEs;
an inactive UE is a UE that does not include the PDU session or the PDN connection; and
the event reporting information further includes at least one of information for the number of UEs not including the PDU session, information for the ratio of the number of active UEs to the number of registered UEs, or information for the ratio of the number of inactive UEs to the number of registered UEs.

4. The method of claim 1, further comprising:
transmitting, to the AF, the event reporting information.

5. A method performed by a network slice access control function (NSACF) in a wireless communication system, the method comprising:
receiving, from a consumer network function (NF), a second message requesting an event subscription for a network slice, wherein the second message is associated with a first message that is transmitted to the NF from an application function (AF), requesting the event subscription for the network slice; and
transmitting, to the consumer NF, event reporting information including information fora number of user equipments (UEs) along with at least one of a protocol data unit (PDU) session or a packet data network (PDN) connection.

6. The method of claim 5, wherein the first message and the second message further include an event identifier, respectively, indicating the number of UEs along with the at least one of the PDU session or the PDN connection.

7. The method of claim 5, wherein:
the first message and the second message further include at least one of an event identifier indicating a number of inactive UEs, respectively, an event identifier indicating a ratio of a number of active UEs to a number of registered UEs or the event identifier indicating the ratio of the number of inactive UEs to the number of registered UEs;
an inactive UE is a UE that does not include the PDU session or the PDN connection; and
the event reporting information further includes at least one of information for the number of UEs not including the PDU session, information for the ratio of the number of active UEs to the number of registered UEs, or information for the ratio of the number of inactive UEs to the number of registered UEs.

8. The method of claim 5, wherein the consumer NF is one of a network exposure function (NEF), an AF, or an NSACF.

9. A consumer network function (NF) in a wireless communication system, the consumer NF comprising:
a transceiver; and
a controller operably coupled with the transceiver and configured to:
receive, from an application function (AF), a first message requesting an event subscription for a network slice,
transmit, to a network slice access control function (NSACF), a second message requesting the event subscription for the network slice in response to receiving, from the AF, the first message, and
receive, from the NSACF, event reporting information including information for a number of user equipments (UEs) along with at least one of a protocol data unit (PDU) session or a packet data network (PDN) connection.

10. The consumer NF of claim 9, wherein the first message and the second message further include an event identifier, respectively, indicating the number of UEs with the at least one of the PDU session or the PDN connection.

11. The consumer NF of claim 9, wherein:
the first message and the second message further include at least one of an event identifier indicating a number of inactive UEs, respectively, the event identifier indicating a ratio of a number of active UEs to a number of registered UEs or the event identifier indicating the ratio of the number of inactive UEs to the number of registered UEs;
an inactive UE is a UE that does not include the PDU session or the PDN connection; and
the event reporting information further includes at least one of information for the number of UEs not including the PDU session, information for the ratio of the number of active UEs to the number of registered UEs, or information for the ratio of the number of inactive UEs to the number of registered UEs.

12. The consumer NF of claim 9, wherein the controller is further configured to:
transmit, to the AF, the event reporting information.

13. A network lice access control function (NSACF) in a wireless communication system, the NSACF comprising:
a transceiver; and
a controller operably coupled with the transceiver and configured to:
receive, from a consumer NF, a second message requesting an event subscription for a network slice, wherein the second message is associated with a first message that is transmitted to the NF from an application function (AF), requesting the event subscription for the network slice, and
transmit, to the consumer NF, event reporting information including information for a number of equipments (UEs) along with at least one of a protocol data unit (PDU) session or a packet data network (PDN) connection.

14. The NSACF of claim 13, wherein the first message and the second message further include an event identifier, respectively, indicating the number of UEs with the at least one of the PDU session or the PDN connection.

15. The NSACF of claim 13, wherein:
the first message and the second message further include at least one of an event identifier indicating a number of inactive UEs, respectively, an event identifier indicating a ratio of a number of active UEs to a number of registered UEs or the event identifier indicating the ratio of the number of inactive UEs to the number of registered UEs;
an inactive UE is a UE that does not include the PDU session or the PDN connection; and
the event reporting information further includes at least one of information for the number of UEs not including the PDU session, information for the ratio of the number of active UEs to the number of registered UEs, or information for the ratio of the number of inactive UEs to the number of registered UEs.
